(19) United States
(12) Patent Application Publication
(10) Pub. No.: US 2007/0280395 A1
(43) Pub. Date: Dec. 6, 2007

(54) Method and device for sampling electrical signals of a multiphase electrical installation

(75) Inventor: Matei Iurascu, Grenoble (FR)

Correspondence Address: STEPTOE & JOHNSON LLP, 1330 CONNECTICUT AVENUE, N.W., WASHINGTON, DC, 20036, US

(73) Assignee: SCHNEIDER ELECTRIC INDUSTRIES SAS, Rueil Malmaison (FR)

(21) Appl. No.: 11/798,120

(22) Filed: May 10, 2007

(30) Foreign Application Priority Data
Jun. 2, 2006 (FR) 06 04944

(51) Int. Cl. H04L 7/00

(52) U.S. Cl. 375/371

(57) ABSTRACT

A method for sampling the electrical signals of a multiphase electrical installation enables the samples on a predetermined phase to be corrected from the samples on the correct phases, with a fixed sampling period, comprising:
(a) supply of samples successively on each of the phases,
(b) superposition of a part of the samples of each of the correct phases over the same fundamental period,
(c) determination of a limit for each of the correct phases,
(d) selection of a series of consecutive samples on each of the correct phases, the first sample of the series having a sampling index equal to the limit, and
(e) correction of a series of the first consecutive samples of the predetermined phase from the values of the samples of the selected series.
   A device for sampling the electrical signals comprising means for supplying samples and processing means enabling implementation of the method described above.

### BACKGROUND OF THE INVENTION

The invention relates to a method for sampling the electrical signals of a multiphase electrical installation enabling the samples on a predetermined phase to be corrected from the samples on the correct phases, the electrical signals on each phase of the installation having a fundamental period and sampling being performed with a fixed sampling period.

The invention also relates to a device for sampling the electrical signals of a multiphase electrical installation enabling the samples on a predetermined phase to be corrected from the samples on the correct phases, the device comprising means for successively supplying samples on each of the phases, and processing means.

### STATE OF THE ART

In multiphase electrical installations, measurement of the current, of the voltage, or of any electrical quantity resulting therefrom, such as for example the active power, the power factor, or the reactive power, generally requires sampling on each of the phases of the installation. This sampling can be performed with a fixed sampling period successively on each of the phases of the installation.

The measurements on such multiphase electrical installations can be impaired by errors occurring for example if the measuring sensor on one of the phases is malfunctioning or disconnected. It is also possible, for any reason such as lack of space or the need to limit the number of cables, for one of the phases of the installation not to be measured. In both cases, the correct phases, i.e. the phases for which the acquired samples have correct values, can be distinguished from predetermined phase for which the values of the samples may be incorrect, for example for one of the reasons given above. In such cases, it is necessary to reconstitute the electrical signal or to correct the values of the samples of the predetermined phase.

Prior art sampling methods allow such a correction to be made, generally not enabling a good precision to be conciliated with simplicity of implementation. In general, known sampling methods require synchronization of the sampling period on the fundamental period of the electrical signals of the installation and/or implementation of a memory for storing the values of the samples the size whereof is significant.

### SUMMARY OF THE INVENTION

The object of the invention is to remedy the shortcomings of the sampling methods of the prior art.

The invention relates to a method for sampling the electrical signals of a multiphase electrical installation whereby the samples can be corrected on a predetermined phase, from the samples on the correct phases, the electrical signals on each phase of the installation having a fundamental period, sampling being performed with a fixed sampling period. The method of the invention comprises:
(a) supply of samples successively on each of the phases, each sample being associated with a sampling index and with a sampling time,
(b) superposition of at least a part of the samples of each of the correct phases over the same fundamental period, associating with each of said samples a relative time defined with respect to the first sample of said correct phase,
(c) determination of a limit for each of the correct phases, said limit being substantially equal to the value of the sampling index of a sample, for which the difference between the relative time associated with said sample and the sampling time associated with the first sample of the predetermined phase is minimized,
(d) selection of a series of consecutive samples on each of the correct phases, the first sample of the series having a sampling index equal to the limit, and
(e) correction of a series of the first consecutive samples of the predetermined phase, said series being corrected from the values of the samples of the series selected in the previous step.

Preferably, the method comprises determination of a reconstituted period corresponding to the difference between the superposed samples over the same fundamental period of any one of the correct phases. Preferably, the reconstituted period is substantially equal to the difference between:
the product of the sampling period by the number of samples supplied during a fundamental period, and
The fundamental period.

According to one embodiment of the method of the invention, the steps involving superposition and determination of a limit are performed simultaneously in an iterative process for each of the correct phases. Preferably, at each iteration of the iterative process, a superposition index is incremented, said index corresponding to a number of reconstituted periods of the relative time associated with each superposed sample. Preferably, the iterative process, for each correct phase, comprises determination of a corrected time difference associated with each superposed sample between the relative time and the sampling time associated with the first sample of the predetermined phase, correction of the time difference enabling the latter to be expressed over one and the same fundamental period, the limit being substantially equal to the sampling index of the sample for which the corrected time difference is minimized. Preferably, determination of a corrected time difference associated with each superposed sample comprises:
determination of the relative time associated with said sample,
determination of a time difference associated with said sample between said relative time and the sampling time associated with the first sample of the predetermined phase, and
correction of the time difference to adjust it to the same fundamental period.

According to one embodiment of the method of the invention, in the selection step and in the correction step, the series of samples of the correct phases selected and the series of the first samples of the predetermined phase comprise a number of consecutive samples equal to a number of samples supplied during a fundamental period.

The invention also relates to a device for sampling the electrical signals of a multiphase electrical installation enabling the samples on a predetermined phase to be corrected from the samples on the correct phases, the electrical signals on each phase of the installation having a fundamental period, the device comprising means for successively supplying samples on each of the phases, and processing means. In the sampling device according to the invention, the processing means perform correction of the samples of the predetermined phase from the samples of the correct phases by means of the method described above.

### BRIEF DESCRIPTION OF THE DRAWINGS

Other advantages and features will become more clearly apparent from the following description of particular embodiments of the invention, given as non-restrictive examples only and represented in the accompanying figures.

FIG. 1 represents a flowchart representing the main steps of an embodiment of the method of the invention.

FIG. 2 represents, for illustrative example purposes, an electrical signal on one of the correct phases of an installation and the samples supplied on this phase.

FIG. 3 represents an example of superposition of the samples of FIG. 2 on a fundamental period.

FIG. 4 represents, in more detailed manner, the superposition step (b) and the step (c) of determining the limits Lj for each correct phase of a three-phase system.

FIG. 5 represents an embodiment of the sampling device of the invention.

FIG. 6 represents an example of an output frame of the conversion means of the sampling device of the invention.

### DETAILED DESCRIPTION OF PREFERRED EMBODIMENTS

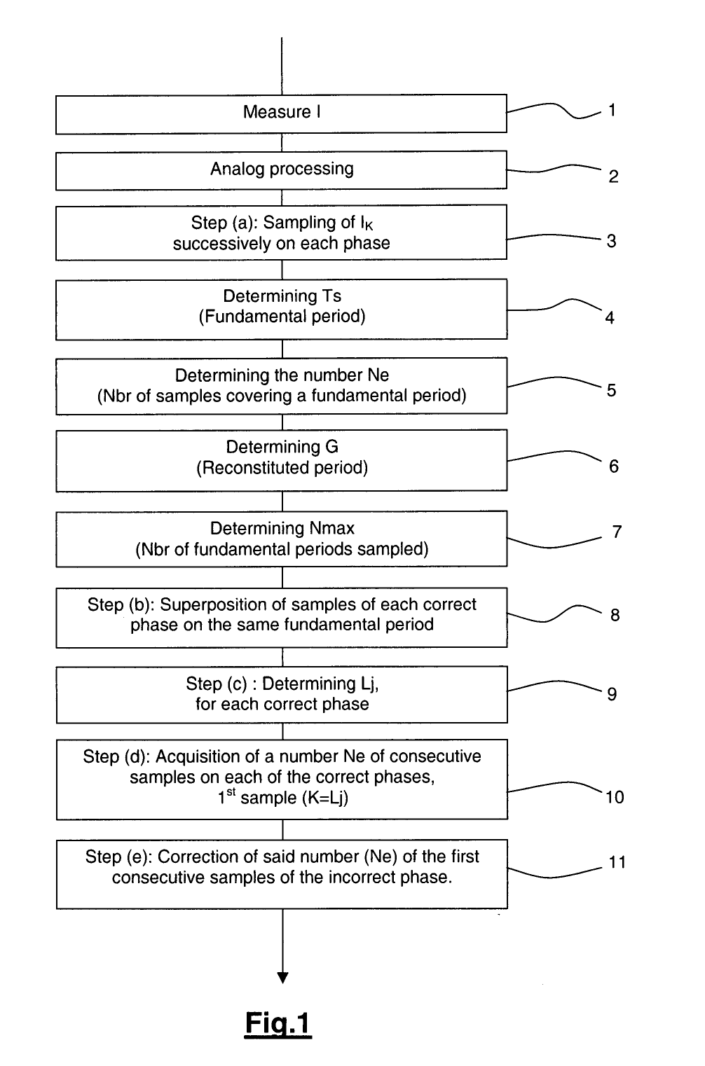

The embodiment of the method of the invention represented in FIG. 1 comprises different steps whereby the electrical signals of the correct phases of a multiphase installation can be sampled and the values of the samples of a predetermined phase of said installation be corrected.

The predetermined phase generally corresponds to a phase of the installation for which the values of the samples are incorrect, whatever the reason for which these values are incorrect, for example the measuring sensor on said phase is faulty, disconnected or non-existent.

A first acquisition step 1 enables electrical signals, i.e. a current I, to be obtained from a current sensor fitted on the correct phases of the installation only. In other embodiments that are not represented, the acquisition step can be an acquisition on all of the phases of the installation, the values of the samples of the predetermined phase being the object of correction by the method of the invention.

What is meant by correct phase is a phase for which the values of the samples are initially correct or representative of the electrical signal measured on said phase. In the multiphase installation on which the method of the invention is implemented, all the phases of the installation are called correct phases, except for the predetermined phase. In certain cases, the samples of the predetermined phase can be correct, the method thus enabling the values of the samples of the predetermined phase to be confirmed or verified.

The electrical signals I of each correct phase are then sent in an analog processing step 2, in this instance involving low-pass analog filtering, during which these electrical signals are processed so as to eliminate the high-frequency components. The low-pass filter used generally comprises a sufficiently high cut-off frequency to eliminate the noise of the electrical signals.

After analog processing 2, the electrical signals are sampled in a step (a) wherein current samples I_{K} are successively supplied on each of the phases. This step (a) is represented in the flowchart of FIG. 1 by a functional box referenced 3. Sampling is performed with a fixed sampling period Te, without any synchronization with the fundamental period Ts of the electrical signals. The sampling period Te is generally much shorter than the fundamental period Ts, and often such as to meet Shannon's criterion, i.e. such that the ratio between the fundamental period Ts and the sampling period on each phase is at least equal to two. The sampling step generally comprises a digital conversion.

The samples I_{K} are supplied successively on each of the phases and in cyclic manner. Each sample is thus associated with a sampling index K and with a sampling time equal to the value of the index K multiplied by the sampling period Te.

After sampling, a sufficient number of current samples I_{K} are therefore available to be able to reconstitute the samples of the predetermined phase or to correct the values of said samples. This sufficient number of samples can correspond to the storage capacity of a processing unit of a sampling device dedicated to implementation of the sampling method. The number Nmax of samples necessary to correct the values of the samples of the predetermined phase, with an acceptable precision, is determined in a subsequent step of the method. This number Nmax of necessary samples is obviously lower than or equal to the number of samples able to be stored in the memories of the processing unit of the sampling device.

In other embodiments, the step 3 of supplying samples can be a simple acquisition of samples already stored in memories and constitute, in this case, the first step of this method.

The samples I_{K} of the electrical signals are then sent to a determination step 4 of the fundamental period Ts of the electrical signals. The fundamental period Ts can be determined by any means known to those specialized in the art. This step of determining the fundamental period Ts can be optional, it being set down that the fundamental period corresponds to the inverse of a known frequency of the power system.

For example, to determine the fundamental period Ts, or the fundamental frequency fs which is equal to the inverse of the period, we can base ourselves on determination of the period of the electrical signals over a sufficiently large time span. This generally begins by checking the sign of each sample of a voltage or current signal and, as soon as the sign of this signal changes, a first time to corresponding to the first zero crossing of this signal is stored in a memory. This process is repeated for a number of zero crossings equal to 2K+1, corresponding to K elapsed fundamental periods Ts of the signal, retaining only the time of the last zero crossing, t_{2K+1}. In this way, the fundamental frequency of the signals can be determined by the following formula:

$$Ts = \frac{{t}_{2 K + 1} - {t}_{0}}{K} .$$

From the fundamental period determined in step 4, the number Ne of samples supplied during a fundamental period is determined in a step 5 of the method of the invention. In general, the number Ne of samples supplied during a fundamental period equal to the sum of one and of the number of integral sampling periods Te during a fundamental period Ts. The number Ne of samples can be determined by the following formula:

$$Ne = INT ( \frac{Ts}{Te} ) ,$$

i.e. by determining the integral part by default of the ratio of the fundamental period Ts over the sampling period Te. It should be noted that the samples supplied during a fundamental period Ts do not correspond to the consecutive samples of any one phase, but to the samples successively supplied on each of the phases of the installation.

From the fundamental period determined in step 4, a reconstituted period G is determined in a step 6. This reconstituted period G corresponds to the difference between the superposed samples I_{K} on one and the same fundamental period. Superposition of the samples on one and the same fundamental period is a subsequent step of the method of the invention involving positioning of each sample of a correct phase over one and the same fundamental period. This superposition step is described in the following in a more detailed manner. The step 6, for its part, enables a reconstituted period G to be previously determined, this period being used by the method of the invention in the subsequent superposition step. The reconstituted period G determined in step 6 is substantially equal to the difference between the product of the sampling period Te by the number Ne of samples supplied during a fundamental period Ts and the fundamental period Ts. The reconstituted period can thereby be determined by the following formula: G=Ne*Te−Ts

From the fundamental period determined in step 4, the number Nmax of samples necessary to correct values of the samples of the predetermined phase with an acceptable precision is determined in a step 7. This number Nmax of necessary samples is substantially equal to an integer of fundamental periods during which sampling is performed. This number is determined according to the total sampling time Tmax, for example by means of the following formula:

$$N max = INT ( \frac{T max}{Ts} ) - 1$$

At least a part of the samples of each correct phase supplied in step 3 are then superposed on one and the same fundamental period of said phase. This superposition step constitutes step (b) of the method of the invention, represented in the flowchart of FIG. 1 by a functional box referenced 8.

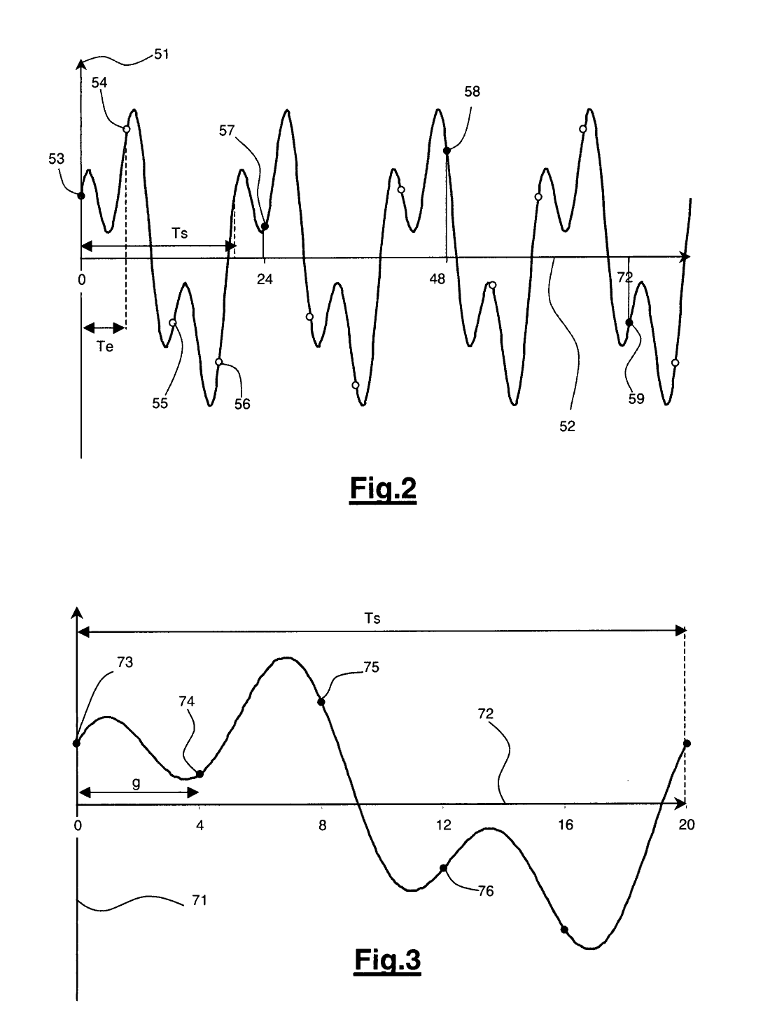

The superposition step is illustrated by the graphs represented in FIGS. 2 and 3. The electrical signal 51 represented in FIG. 2 was obtained on a correct phase, hereinafter called P1, of an installation comprising four phases, i.e. P1, P2, P3 and neutral. The electrical signal on each of the phases of the system presents a fundamental period Ts of 20 ms. The signal 51 is represented versus time 52 over a period equal to about four times the fundamental period. The sampling period Te used is 6 seconds. The consecutive points of FIG. 2 correspond to a sampling being made and are therefore separated by a time equal to the sampling period, but only the dark points are representative of the samples of the electrical signal of phase P1 represented in FIG. 2. As the installation comprises four phases, the samples of the signal of phase P1 are separated by a time equal to four times the sampling period Te, i.e. 24 ms. It should be noted that this example is given for illustrative purposes only, and that the sampling period Te chosen does not enable Shannon's criterion to be verified. Thus, the consecutive samples of phase P1, represented by the dark circles bearing references 53, 57, 58 and 59, are respectively taken at times of 0, 24, 48 and 72 ms. The samplings on the other phases are represented by white circles. For example, the samplings represented by the white circles bearing references 54, 55 and 56 represent the sampling times of sampling successively performed on phases P2, P3 and the neutral.

Superposition of the samples of a phase on the same fundamental period involves determining a relative time, for each of these samples, that corresponds to the temporal position of the sample with respect to a time reference of said fundamental period. Generally, this time reference is defined with respect to the sampling time of the first sample of the phase involved.

In the case illustrated in FIGS. 2 and 3, the time reference is therefore the temporal position of the first sample 53 of the electrical signal of the phase P1. The first sample 53 of the signal of the phase P1 is therefore, after superposition, represented on the axes 71 and 72 of FIG. 3 by the sample 73. This sample therefore constitutes the first sample of the set of superposed samples of the phase P1, on a sampling period. The second sample 57 of the signal of the phase P1 is for its part associated with a sampling time of 24 ms, i.e. 4 ms after the time reference of the second fundamental period of the signal of the phase P1. This second sample 57 is therefore generally associated with a relative time of 4 ms and, after superposition, it is represented in FIG. 3 by the sample 74. In the same way, the third sample 58 of the signal of the phase P1 is associated with a sampling time of 48 ms, i.e. 8 ms after the time reference of the third fundamental period of the signal of the phase P1. This third sample 58 is therefore also associated with a relative time of 8 ms and, after superposition, it is represented in FIG. 3 by the sample 75. By a similar method, the fourth sample 59 is associated with a relative time of 12 ms and, after superposition, it is represented in FIG. 3 by the sample 76.

The samples of the phase P1 are therefore separated by a time of 4 ms which corresponds to the reconstituted period determined in step 6 of the method of FIG. 1. Thus, in the superposition step (b) of the method of the invention or in step 8 of the embodiment of FIG. 1, each sample of a given phase is associated with a sampling time and with a relative time that is substantially equal to the value of a superposition index M multiplied by the reconstituted period G. The consecutive samples 53, 57, 58 and 59 of the phase P1, as represented in FIG. 2, are therefore associated with a sampling index K respectively equal to 1, 5, 9 and 13 and with a superposition index M respectively equal to 0, 1, 2 and 3. This superposition step can be performed, for each correct phase of the installation, by an iterative process in which the superposition index M corresponding to the number of reconstituted periods is incremented.

The superposition step 8 is followed by a step 9 of determining a limit Lj for each of the correct phases of the installation, said limit being equal to the value of the sampling index K of a sample I_{Lj}, for which the difference between the relative time associated with said sample and the sampling time associated with the first sample of the predetermined phase is minimized. This step 9 of the embodiment represented in FIG. 1 corresponds to step (c) of the method of the invention. This step 9 of determining a limit Lj for each of the correct phases of the installation can be performed by an iterative process in which the superposition index M is incremented.

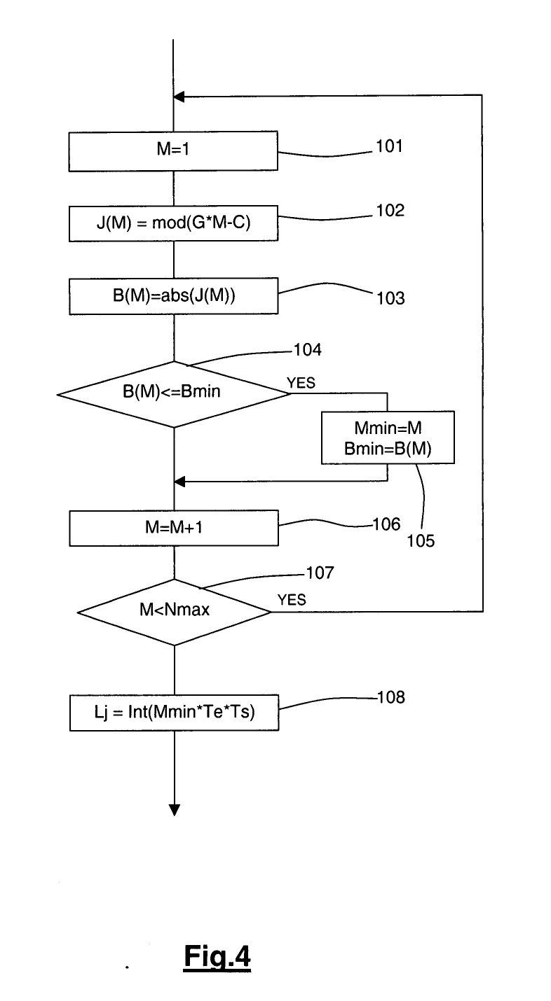

According to a preferred embodiment, the superposition step 8 and the step 9 of determining a limit Lj are performed for each of the correct phases of the installation by the same iterative process in which the superposition index M is incremented. This iterative process of steps 8 and 9, corresponding to the superposition step (b) and to the step (c) of determining a limit Lj, is performed according to the flowchart represented in FIG. 4. At each iteration of the iterative process, the superposition index M is incremented, said superposition index corresponding to a number of reconstituted periods G of the relative time associated with each superposed sample.

The iterative process, for a given correct phase, and for each sample of said correct phase, comprises:
an initialization step 101 wherein the first iteration is initialized on the superposed second sample, by stating that the superposition index M is equal to 1,
determination steps 102 and 103 for determining the absolute value B(M) of a corrected time difference J(M), associated with each superposed sample, between the relative time and the sampling time associated with the first sample of the predetermined phase, correction making it possible to express the time difference on one and the same fundamental period,
a testing step 104 to determine whether the absolute value of the corrected time difference B(M), determined in the steps 102 and 103, is lower than a threshold value stored in a first register Bmin,
a step 105, implemented when the test of step 104 is positive, during which the value of the superposition index M is stored in a second register Mmin and the value of the first register Bmin is replaced by the time difference B(M),
an incrementation step 106 of the superposition index M,
a testing step 107 to stop the iterative process when the superposition index M is greater than the number Nmax of samples necessary to correct values of the samples of the predetermined phase, and
a step 108 for determining the limit Lj as being substantially equal to the integer part by default of the product of the value of the second register Mmin multiplied by the fundamental period Ts and by the sampling period Te.

In more detailed manner, the step 102 of determining a corrected time difference J(M) begins, for a sample of the correct phase considered, by determination of the relative time associated with said sample, defined with respect to the first sample of said correct phase, by multiplying the reconstituted period G by the superposition index M.

Then, for this same sample of the correct phase considered, a time difference associated with said sample is determined, between the relative time, i.e. the product G*M of the reconstituted period G by the superposition index M, and the sampling time associated with the first sample of the predetermined phase. In the case of an installation with four phases P1, P2, P3 and N, and considering that the phase P2 is the predetermined phase, the time difference associated with a sample of the correct phases P1, P3 and N is substantially equal to the difference between the product G*M and a constant Cj varying according to the phase j considered. For the phase P1, the constant Cₚ₁ is equal to once the sampling period Te, the latter being counted positively due to the fact that the first sample of the predetermined phase P2 is lagging by once the reconstituted period with respect to the first sample of the phase P1. For the phase P3, the constant C_{P3} is equal to once the sampling period Te, the latter being counted negatively due to the fact that the first sample of the predetermined phase P2 is leading by once the reconstituted period with respect to the first sample of the phase P3. For the phase N, the constant C_{N} is equal to twice the sampling period Te, the latter being counted negatively due to the fact that the first sample of the predetermined phase P2 is leading by twice the reconstituted period with respect to the first sample of the phase N. Thus, in the case of an installation with four phases P1, P2, P3 and N, and considering that the phase P2 is incorrect, the time differences associated with a sample of the correct phases P1, P3 and N are respectively equal to G*M−Te, G*M+Te and G*M+2Te.

Then, for this same sample of the correct phase considered, a correction of the time difference is made to express this difference over one and the same fundamental period. Thus, when the time difference associated with a sample is greater than the fundamental period, said difference is corrected by determining a remainder that corresponds to the rest of said difference divided by the fundamental period Ts to obtain an integer. This remainder can also be expressed by a mathematical function, known by the name of modulo, by a formula of the type Mod(a,b)=a−b*INT(a/b), the function INT(a/b) corresponding to the integer part by default of a/b. Thus, in the case of an installation with four phases P1, P2, P3 and N, and considering that the phase P2 is incorrect, the corrected time differences J(M) associated with a sample of the correct phases P1, P3 and N are respectively equal to Mod(G*M−Te,Ts), Mod(G*M+Te,Ts) and Mod(G*M+2Te,Ts).

Steps 8 and 9 involving superposition and determination of a limit Lj, dealt with in detail above by the description of FIG. 4, are followed by a step 10 of selection of a series of consecutive samples on each of the correct phases, the first sample of the series having a sampling index K equal to said limit Lj, the number of samples of said series being equal to the number Ne of samples supplied during a fundamental period determined in step 5. This step 10 of the embodiment represented in FIG. 1 corresponds to step (d) of the method of the invention.

Step 10 of selection of a series of consecutive samples on each of the correct phases is followed by a step 11 of correction of a series of the first consecutive samples of the predetermined phase, the number of samples of said series being equal to the number Ne of samples supplied during a fundamental period. The series of the first samples of the predetermined phase is corrected from the values of the samples of the series selected in the previous step 9. This step 11 of the embodiment represented in FIG. 1 corresponds to step (e) of the method of the invention.

In this correction step (11) or (e), each sample of the series of the first samples of the predetermined phase can be corrected from samples having the same rank of the series of consecutive samples of each of the correct phases. The method of the invention does in fact enable series of Ne consecutive samples to be determined, on each of the phases of the installation, for which the samples of the same rank of each of said series can be considered to have been supplied substantially at the same time, or more exactly, with a minimized time difference. Taking the laws of electricity governing the electrical signals of each of the phases into consideration, it is therefore possible, from the set of samples having the same rank on each of the series, to correct the sample of the predetermined phase according to the other samples of the correct phases.

In the embodiment of FIG. 1, the sampled electrical signals are currents. In this case, it is known that the sum of the currents of each phase is equal to zero. Thus, the sum of the current samples of each of the series having the same rank is equal to zero. The sample of the predetermined phase can therefore be corrected according to the samples of the correct phases. By performing this correction on each sample of the series of samples of the predetermined phase, the electrical signal, i.e. the current, of said predetermined phase can therefore be reconstituted.

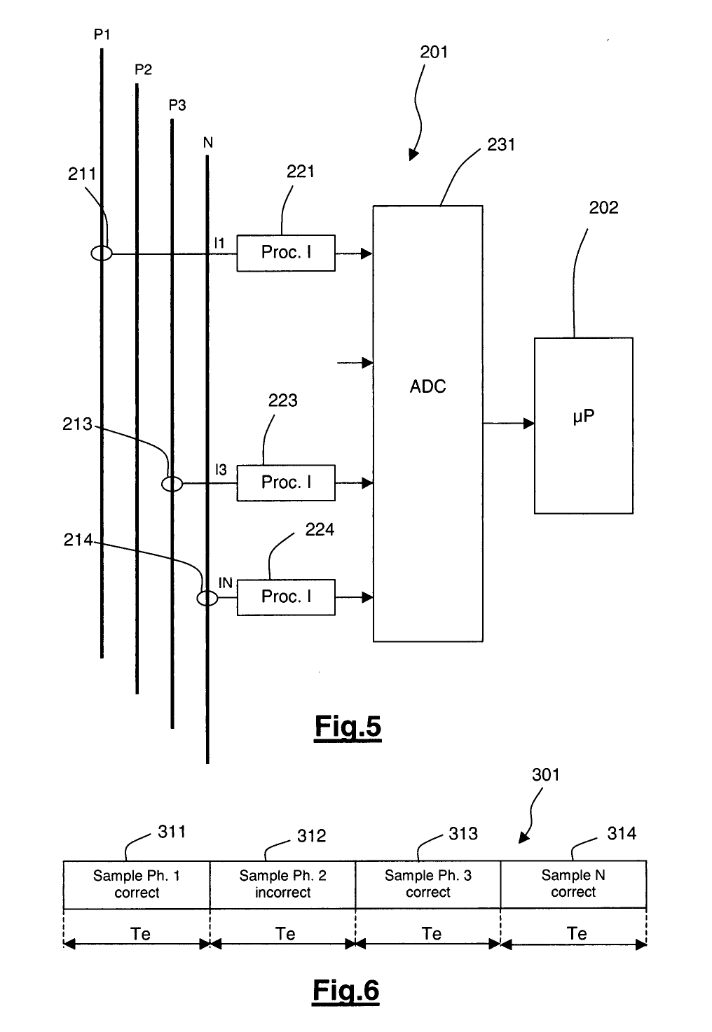

The sampling device of the invention is represented in FIG. 5. The multiphase installation on which the device of the invention is implemented is a four-phase installation, i.e. comprising four phases, viz. three phases P1, P2 and P3 plus neutral N. The sampling device represented in FIG. 5 comprises means for successively supplying samples 201 on each of the phases, and processing means 202. The means for supplying samples 201 for their part comprise current sensors 211, 213 and 214 respectively fitted on the phases P1, P3 and N called correct phases. As for the phase P2, it does not comprise a current sensor and is therefore qualified as predetermined phase due to the fact that the current samples of phase 2 do not effectively correspond to quantities representative of the current. The sensors 211, 213 and 214 are respectively connected to analog processing means 221, 223 and 224. These processing means can be analog filters to attenuate a high-frequency noise and to prevent aliasing of the current signal harmonics spectrum. The means for supplying samples 201 generally comprise a digital converter 231 comprising four measurement inputs connected to the four phases of the four-phase installation for sampling and digital conversion of the electrical current signals with a fixed sampling frequency. In the case of FIG. 5, the second input of the converter corresponding to the predetermined phase P2 is not connected, and the samples made on this input are therefore incorrect. The converter 231 comprises an output for supplying the samples of each of the phases in the form of a frame via suitable multiplexing means.

As represented in FIG. 6, the output frame 301 of the digital conversion means comprise four samples 311, 312, 313 and 314 corresponding to the current on each of the phases P1, P2, P3 and N of the three-phase installation. In the case represented in FIG. 6, each sample of the frame 301 extends over a time equal to the fundamental period Te.

The processing means 202 perform correction of the samples of the predetermined phase from samples of the correct phases by means of the sampling method described in the above. These processing means comprise a memory module, not represented, for storing the current samples of each of the phases.

One advantage of the invention is in particular to minimize the size of this memory module of the processing means.

Another advantage of the invention is the absence of synchronization of the sampling frequency, which in particular enables the processing means to be simplified.

1. Method for sampling the electrical signals of a multiphase electrical installation enabling the samples on a predetermined phase to be corrected from the samples on the correct phases, the electrical signals on each phase of the installation having a fundamental period, sampling being performed with a fixed sampling period, method comprising:
(a) supply of samples successively on each of the phases, each sample being associated with a sampling index and with a sampling time,
(b) superposition of at least a part of the samples of each of the correct phases over the same fundamental period, associating with each of said samples a relative time defined with respect to the first sample of said correct phase,
(c) determination of a limit for each of the correct phases, said limit being substantially equal to the value of the sampling index of a sample, for which the difference between the relative time associated with said sample and the sampling time associated with the first sample of the predetermined phase is minimized,
(d) selection of a series of consecutive samples on each of the correct phases, the first sample of the series having a sampling index equal to the limit, and
(e) correction of a series of the first consecutive samples of the predetermined phase, said series being corrected from the values of the samples of the series selected in the previous step.

2. Method according to claim 1, comprising determination of a reconstituted period corresponding to the difference between the superposed samples over the same fundamental period of any one of the correct phases.

3. Method according to claim 2, wherein the reconstituted period is substantially equal to the difference between:
the product of the sampling period by the number of samples supplied during a fundamental period, and
the fundamental period.

4. Method according to claim 1, wherein the steps of superposition and determination of a limit are performed simultaneously in an iterative process, for each of the correct phases.

5. Method according to claim 4, wherein a superposition index is incremented at each iteration of the iterative process, said index corresponding to a number of reconstituted periods of the relative time associated with each superposed sample.

6. Method according to claim 5, wherein the iterative process, for each correct phase, comprises determination of a corrected time difference associated with each superposed sample between the relative time and the sampling time associated with the first sample of the predetermined phase, correction of the time difference enabling the latter to be expressed over one and the same fundamental period, the limit being substantially equal to the sampling index of the sample, for which the corrected time difference is minimized.

7. Method according to claim 6, wherein determination of a corrected time difference associated with each superposed sample comprises:
determination of the relative time associated with said sample,
determination of a time difference associated with said sample between said relative time and the sampling time associated with the first sample of the predetermined phase, and
correction of the time difference to adjust it to the same fundamental period.

8. Method according to claim 1, wherein, in the selection step and the correction step, the series of samples of the selected correct phases and the series of the first samples of the predetermined phase comprise a number of consecutive samples equal to a number of samples supplied during a fundamental period.

9. Device for sampling the electrical signals of a multiphase electrical installation enabling the samples on a predetermined phase to be corrected from the samples on the correct phases, the electrical signals on each phase of the installation having a fundamental period, the device comprising:
means for successively supplying samples on each of the phases, and
processing means,
wherein the processing means enable the samples of the predetermined phase to be corrected from the samples of the correct phases by means of the method according to claim 1.
